(19) United States
(12) Patent Application Publication
(10) Pub. No.: US 2009/0156202 A1
(43) Pub. Date: Jun. 18, 2009

(54) METHODS, APPARATUS AND SYSTEMS FOR INFORMATION EXCHANGE USING PORTABLE ELECTRONIC DEVICES

(75) Inventors: Chris Reiss, Salem, MA (US); J. Graham Zahoruiko, Grafton, MA (US); Robert F. Angelo, Framingham, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: CELLTAK CORPORATION, Natick, MA (US)

(21) Appl. No.: 12/252,792

(22) Filed: Oct. 16, 2008

Related U.S. Application Data
(60) Provisional application No. 60/996,808, filed on Dec. 6, 2007.

(51) Int. Cl. H04W 4/00; H04L 27/00

(52) U.S. Cl. 455/426.1; 375/295

(57) ABSTRACT

The invention provides, in some aspects, a system for information exchange including groups of portable digital devices that exchange one or more items of data (“first data”) when placed in a range of one another. That exchange is performed by the devices sonically, e.g., using sound waves conducted by air or other medium between the devices—or, if the devices are touching, conducted by plastic or other materials of which they are made. Alternatively, or in addition, the exchange can be conducted optically, via digital data networks, or otherwise.

The application claims the benefit of filing of U.S. Patent Application Ser. No. 60/996,808, filed Dec. 6, 2008, entitled “Method for Exchanging Contact Information Between Two Cellular Telephones,” the teachings of which are incorporated herein by reference.

### BACKGROUND OF THE INVENTION

The invention relates to information exchange utilizing personal electronic devices. It has application, by way of non-example, in the exchange of personal, business and other information between individuals that are in proximity to one another.

An odd dichotomy in human interaction reinforces the notion that, despite all of our technological advances, we remain creatures of habit. Take the exchange of phone numbers, for example. Upon first meeting a new acquaintance, we are just as likely to verbally exchange and jot down each others' phone numbers as we are to hand business cards to one another. Most persist in these time-honored traditions, even when armed to the teeth with cell phones, personal digital assistants, portable computers and the like.

Financial transactions are no different. Though few would hesitate to wire funds or credit information to a merchant across town, state or country, many prefer to physically hand over cash or hand-written check when purchasing in person.

These are just a few examples of how we stick with our ways when it comes to our in person dealings, even though technology readily at hand might facilitate our personal and business communications.

An object of the invention is to provide improved methods, apparatus and systems for information exchange.

A further object of the invention is to provide such methods, apparatus and systems as can be readily used by people during the course of their everyday affairs.

A still further object of the invention is to provide such methods, apparatus and systems as can be implemented using portable electronic devices.

A related object of the invention is to provide such methods, apparatus and systems as can be implemented using devices such as cell phones, personal digital assistants, portable computers, and the like, within the regular experience of the average user.

Yet a still further object of the invention is to provide such methods, apparatus and systems as can be implemented at low cost, e.g., on devices available in the marketplace.

### SUMMARY OF THE INVENTION

The foregoing are among the objects attained by the invention which provides, in some aspects, a system for information exchange including first and second portable digital devices that exchange one or more items of data (“first data”) when placed in a range of one another. That exchange is performed by the devices sonically, e.g., using sound waves conducted by air or other medium between the devices—or, if the devices are touching, conducted by plastic or other materials of which they are made.

A system of the type described above can be used, for example, by persons meeting at a conference, in a restaurant, or some other locale to exchange information using their respective mobile or “cell” phones, personal digital assistants (PDAs), music players, watches (or time pieces), or other portable electronic devices. Where the devices are cell phones, for example, the sonic exchange can be effected via their respective microphones/mouthpieces and loudspeakers/earpieces.

According to further related aspects of the invention, the first and second portable digital devices of a system as described above exchange the “first data” when at least one of them is activated for such exchange, e.g., by a user. Such activation can be by way of manipulation of one or more buttons or other actuators (e.g., a switch or switches), by voice command, selection of an icon, and so forth.

In related aspects, the invention provides a system as described above in which the first and second portable digital devices exchange the first data when placed in a range (distance) within which they can communicate sonically. Transmit volume(s) and/or receive sensitivity(ies) of the devices can be set so that the exchange between the first and second devices is exclusive of any other devices that are in sonic range and with which they are otherwise capable of exchanging data.

Turning back to the example, persons meeting in a restaurant (for example) using a system of the type described above can initiate an exchange of information by holding their cell phones in close proximity of one another and manipulating a button (or sequence of buttons). In systems according to some aspects of the invention, holding the devices in proximity facilitates sonic communication between them without risk that other devices in the vicinity will pick up the exchange, erroneously, surreptitiously, or otherwise.

The first and second portable digital devices are, according to other related aspects of the invention, associated with first and second entities, e.g., owners or users. Moreover, the aforementioned first data can be information about one and/or the other of those entities or their respective devices. This can include, for example, an exchange I.D., phone number(s), name(s), address(es), employment information, financial information, medical status(es), health status(es), romantic and/or marital partnership status(es) and/or other data (including, by way of non-limiting example, music files, picture files, and/or other data files).

Other aspects of the invention provide a system as described above in which the devices exchange the first data in both directions. Thus, whereas in systems according to some aspects of the invention, the so-called first data is transferred only in one direction, i.e., from one device to the other, in other aspects, similar (or disparate) data is transferred in both directions, i.e., from each device to the other. Systems according to this aspect can be used, to continue the example above, to facilitate a two-way exchange of addresses, phone numbers and employment statuses between persons meeting in a restaurant.

Still other aspects of the invention provide a system as described above in which the first and second devices exchange second data, in one or both directions, subsequent to exchange of the first data. That second data can include information of the type enumerated above (e.g., exchange IDs, phone number(s), name(s), address(es), employment information, etc.), by way of example, and it, too, can be exchanged sonically between the devices. The second data can be exchanged via other media as well, however. Thus, continuing the example above, following a sonic exchange of addresses between cell phones of restaurant-goers, cell phones in a system according to the invention can use wireless networks, telephone networks or otherwise, to transfer other personal or business information.

According to other aspects of the invention, the exchange of the first data between the first and second devices in a system according to the invention can effect an exchange of second data between one or more other instrumentalities associated with those devices and/or their respective owner/users. Such an exchange can be automatic or it can be initiated at the behest of either or both devices—e.g., in response to button-presses, voice commands, icon selection or other acts by their respective owners/users. The other instrumentalities can include computer systems, bank accounts, credit accounts, data services, and/or social networking site servers, all by way of non-limiting example.

In a variation on the example above, following an exchange of addresses between cell phones of restaurant-goers, cell phones in a system according to the invention can be used to effect a transfer of personal information between social networking site servers used by those persons.

By way of further example, a system of the type described above can be used by a retailer and customer at an open-air market. To that end, once the buyer has identified goods to purchase, the buyer and seller can hold their cell phones in close proximity, after or while keying in a sequence of buttons, issuing voice commands, selecting one or more icons, etc., to initiate the exchange of a sales confirmation code between the phones. In turn, one or both phones can contact banking servers for the retailer and customer to initiate a funds transfer.

According to other aspects of the invention, the first and second devices perform the exchange of at least the aforementioned first data irrespective of any of (i) prior association of those devices with one another, and (ii) prior association of entities associated with those devices with one another. Thus, by way of non-limiting example, the devices and/or their respective owners/users need not have been identified to one another as “paired,” “buddies,” or otherwise.

Further aspects of the invention provide systems as described above in which the devices exchange at least the first data electrically, electomechanically, optically, magnetically or mechanically—in lieu of (or in addition to) sonically—once placed in range (e.g., in contact or near-contact) with one another. In some aspects of the invention, the second data can be transferred this same way, as well. These exchanges can be effected, for example, by mating lock-and-key, tongue-and-groove or other mechanical mechanisms whose interactions (e.g., contact pressure) are, preferably, variable to permit encoding of exchanged data; by a magnetic switch and/or key mechanism that is, again, preferably variable; and, so forth.

In other aspects, the invention provides a system for information exchange that includes first and second devices that are adapted for variable displacement relative to one another and for exchange of data when in a communications range of one another. At least one of the devices initiates an exchange of first data between one or more other instrumentalities associated with the first and second devices or their respective entities (e.g., owners or users) when those entities each take at least one volitional act with respect to their respective devices. At least one of those volitional acts is one of placing at least one of the first and second devices in range of the other.

In related aspects, the invention provides a system as described above in which the first and second devices are coupled for communications sonically, mechanically, electromechanically, optically, magnetically, via direct electrical connection, and/or via one or more networks, and wherein the communications range is the range over which they can maintain such communications coupling. In still further related aspects of the invention, a system of the type described above includes a network with which the first and second devices can communicatively couple.

In other related aspects of the invention, in a system as described above, at least one of the devices initiates the exchange of data between the associated instrumentalities in response to a further volitional act by the entity associated with that device, e.g., a pressed button (or sequence of buttons), a voice command, selection of an icon (e.g., representative of the other entity or device), and so forth.

An identification service provided, for example, in other aspects of the invention, can transmit to the first device an identifier representative of the second device and/or the entity associated therewith. That identifier can be, for example, a picture, a numerical code, a name, and so forth. In some aspects of the invention, that identifier is unique at least with respect to other devices and/or entities which may be in range of the first device. The device receiving such an identifier can display it or an associated icon (or other indicator) to the user to facilitate his/her selecting a device and/or entity the associated instrumentality with which to initiate an exchange.

A system of the type described above can be used, for example, by a vendor and a prospective customer at a convention center in which their respective PDAs are joined, e.g., by a common wireless network. Following expression of interest by the customer, the vendor can select an icon on his or her PDA identifying the customer (e.g., from among icons of other potential customers on the common network) and, thereby, effect a transfer of marketing literature from the vendor's enterprise server to the prospective customer's e-mail service. Unlike the prior art, such a transfer can take place without the customer specifying his e-mail address to the vendor. Moreover, the transfer can be exclusive with respect to instrumentalities (e.g., e-mail services) of any other prospective customers present at the convention or otherwise in actual or potential communications coupling distance range of the vendor's PDA.

Still further aspects of the invention provide systems as described above in which any of the first device, second device and/or identification service includes proximity detection functionality for determining a relative proximity of the first and second devices. This can be used to filter identifiers (or other associated indicia) displayed on one (or both) of the devices for selection of the other and/or its associated entity. Continuing the example above, this functionality can be used to filter identifiers transmitted to and/or corresponding icons displayed by the vendor's PDA, following expression of interest by the customer, thus, facilitating selection of the icon identifying the customer (as opposed to those identifying other prospective customers on the common network whose devices are not close, visible vicinity of the vendor).

In related aspects of the invention, the first and second devices are coupled for communications sonically, electrically, electomechanically, magnetically or mechanically, by a network (wired or wireless), or otherwise; the first and second devices can be portable electronic devices cell phones, personal digital assistants (PDAs), music players, by way of example; the other instrumentalities can be computer systems, bank accounts, credit accounts, data services, and/or social networking site servers, by way of example; and, the associated entities can be owners and/or users of the respective devices, by way of example.

Related aspects of the invention provide systems as described above in which the exchange of data occurs between three or more devices that are in range of one another.

Further aspects of the invention provide devices for use in systems of the type described above.

Still further aspects of the invention provide methods of operating such systems and/or the devices that make them up.

These and other aspects of the invention are evident in the text that follows and in the drawings.

### BRIEF DESCRIPTION OF THE DRAWINGS

A more complete understanding of the invention may be attained by reference to the drawings, in which:

FIG. 1 depicts a system 10 for information exchange according to one practice of the invention;

FIG. 2 depicts a data flow between devices exchanging information sonically according to one practice of the invention;

FIG. 3 depicts a data flow between devices exchanging information sonically according to another practice of the invention, in which one or more of the devices is activated by the user to initiate the exchange;

FIG. 4 depicts a data flow between devices exchanging information sonically according to another practice of the invention, in which the devices exchange at least some information non-sonically;

FIG. 5 depicts a data flow between devices exchanging information sonically according to another practice of the invention, in which the devices effect further exchange of information between associated instrumentalities;

FIG. 6 depicts a data flow between devices exchanging information sonically according to another practice of the invention, in which the devices effect further exchange of data with associated instrumentalities; and

FIG. 7 depicts a data flow for in a handshake between devices, e.g., to validate one another and/or to otherwise initiate a data exchange.

### DETAILED DESCRIPTION OF THE ILLUSTRATED EMBODIMENT

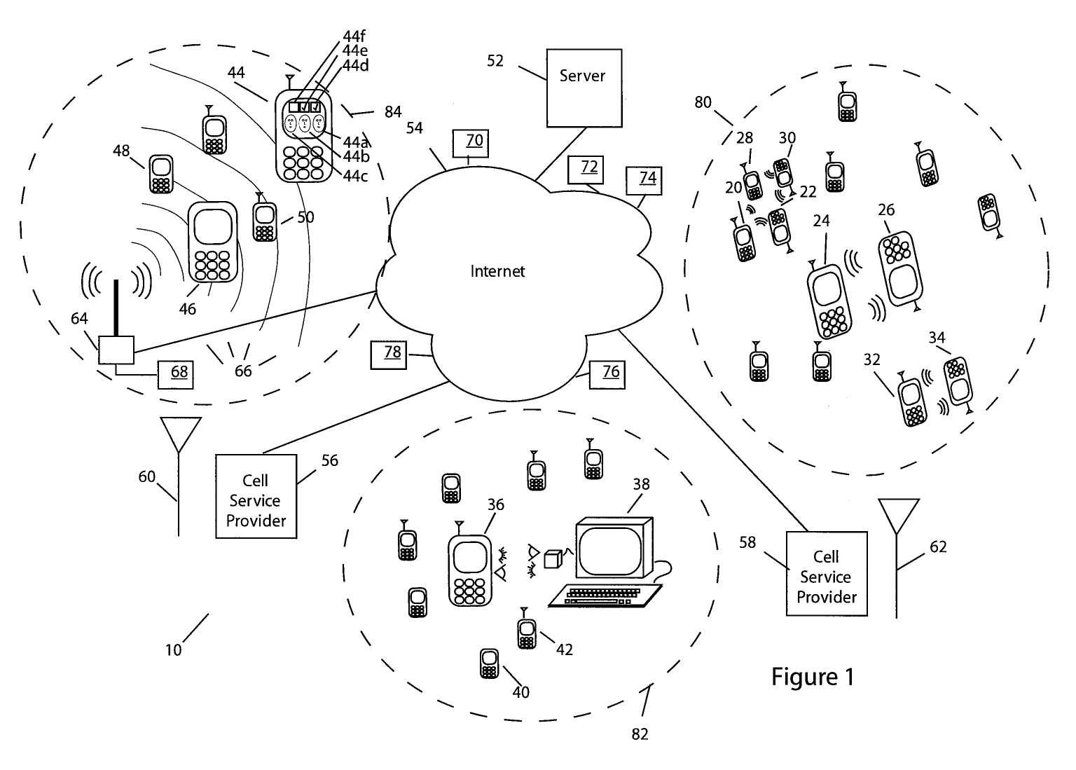

FIG. 1 depicts a system 10 for information exchange according to one practice of the invention. The system 10 includes a plurality of digital devices, some of which are denoted here as devices 20-50. The devices, which may be cell phones, personal digital assistants, portable computers, desktop computers (e.g., in the case of device 38), music players, watches (or time pieces), or other electronic devices, are coupled for communication in various combinations, as discussed below. The illustrated devices 20-50 are associated with respective owners, users or other such operators (not shown) who (i) carry, wear or otherwise transport the devices, thereby, bringing them within data transfer range of other such devices, and (ii) who, optionally, activate them for data transfer in accord with the teachings hereto. Those owners, users or other operators are generally referred to herein as “entities,” although, they may also be referred to as “owners”, “users”, or “operators”, without change of meaning.

One or more of the devices 20-50 may also be coupled with transaction server 52 via the Internet 54 and/or via one or more additional communications networks—including, by way of non-limiting example, cellular networks (exemplified, here, by cellular service providers 56, 58, and respective cell towers 60, 62), and/or network 66—again, as discussed below.

Digital data devices 20-50 comprise conventional devices of the indicated types (i.e., cell phones, personal digital assistants, portable computers, desktop computers, music players, watches (or time pieces), or other electronic devices) of the type commercially available in the marketplace as adapted in accord with the teachings hereof. In this latter regard, such adaptation may be effected via downloading applications, applets, apps, firmware upgrades, software upgrades, and the like, suitable for implementing the novel information exchange mechanisms and methodologies discussed herein. In typical embodiments of the invention, devices 20-50 are portable, though, the invention can be practiced with transportable and fixed devices (such as desktop computer 38), as well. One or more of the devices 20-50 may incorporate hardware (e.g., chipsets), software, antenna and other commonly known mechanisms of the type supporting telephony and/or data communications to others of the devices 20-50, as well as to transaction server 52 and other instrumentalities on the Internet 54 or other networks (e.g., network 66).

Transaction server 52 comprises a conventional digital data processor of the type used for client-server operations over a computer network, for example, the Internet, as adapted in accord with the teachings hereof. Although operating as a server in the illustrated embodiment, it will be appreciated that the functionality attributed herein to server 52 may also be implemented in device 52 operating as a peer in a peer-to-peer network or via alternative mechanisms/architectures known the art art (as adapted in accord with the teachings hereof). Though shown disposed remotely from the devices 20-50, in the illustrated embodiment, in other embodiments the transaction server 52 may be disposed locally with respect to one or more of those devices (e.g., on the same local area network).

Cellular networks, including, service providers 56, 58 (and respective towers 60, 62) operate in the conventional manner known in the art—albeit, in the illustrated embodiment, transporting data of the type described below.

Access point 64 comprises a conventional wireless access point of the type known in the art for establishing a wireless network 66 for devices, e.g., 44-50, in a vicinity thereof. The access point 64 may support 802.11a, 802.11b, 802.11g, 802.11n, and/or other complimentary or competing wireless protocols in the conventional manner or otherwise. The access point 64 may also be coupled to, supplemented and/or supplanted by, a wired network (not shown) supporting Ethernet or other wired protocol communications between and among the connected devices in the conventional manner or otherwise. Regardless, for sake of convenience, such communications (whether wireless, wired, or both) are identified herein by reference to access point 64 and/or network 66.

In some embodiments, the access point 64 is coupled to an identification server 68 that facilitates identification of devices and/or their respective owners/users. That server 68 may be implemented on a conventional digital data processor of the type used for client server operations over a network, for example, network 66, as adapted in accord with the teachings hereof. The identification server may be disposed locally with respect to access point 64 (e.g., on the same local area network) or remotely, e.g., coupled by one or more intervening networks, including the Internet 54.

An identification service provided, for example, in some embodiments of the invention, can transmit to the first device an identifier representative of the second device and/or the entity associated therewith. That identifier can be, for example, a picture, a numerical code, a name, and so forth. That identifier can be unique, semi-unique or otherwise at least with respect to other devices and/or entities which may be in range of the first device. The device receiving such an identifier can display it or an associated icon (or other indicator) to the user to facilitate his/her selecting a device and/or entity the associated instrumentality with which to initiate an exchange.

One or more other instrunentalities 70-78 may be coupled to Internet 54, as well, for communication with transaction server 52 and/or various ones of the devices 20-50. Those instrumentalities 70-78 may comprise computer systems, bank accounts, credit accounts, data services, and/or social networking site servers, all by way of non-limiting example, and they may be implemented on digital data processing or other devices of the type commonly used for such purposes in the art. Though shown disposed remotely from the devices 20-50 and transaction server 52, in the illustrated embodiment, in other embodiments the other instrumentalities may be disposed locally with respect to one or more of those devices and/or server (e.g., on the same local area network).

In the drawing, multiple devices are disposed in various locales 80-84, such as restaurants, conference centers, markets, or otherwise, all by way of non-limiting example. In the drawing, this includes devices 20-34 in locale 80, devices 36-40 in locale 82, and devices 44-50 in locale 84, all of which devices are assumed to be adapted as discussed above to exchange data in accord with the invention—though, in practice, a lesser or greater number of devices in the respective locales may be so adapted. Of course, it will be appreciated that the illustrated locales are shown by way of example and that the invention may be practiced with lesser or greater numbers thereof.

It will be further appreciated that the system shown in FIG. 1 represents one embodiment of the invention and that other embodiments may incorporate greater or lesser numbers of the illustrated elements or otherwise.

In the discussion that follows, operation of devices and systems according to the invention is often discussed in regard to interactions between pairs of devices. Such pairs are shown, by way of example, as devices 24, 26, devices 32, 34, and devices 36, 38, and so forth. It will be appreciated that this is by way of example and that other pairs and/or other groupings of devices according to the invention can interact in such manner. Examples include the group formed by devices 20, 22, 28, 30, the group formed by devices 44-50, and so forth. It will also be appreciated that the terms “data” and “information” are used synonymously herein, at least, in regard to exchanges between devices, servers, other instrumentalities and/or elements.

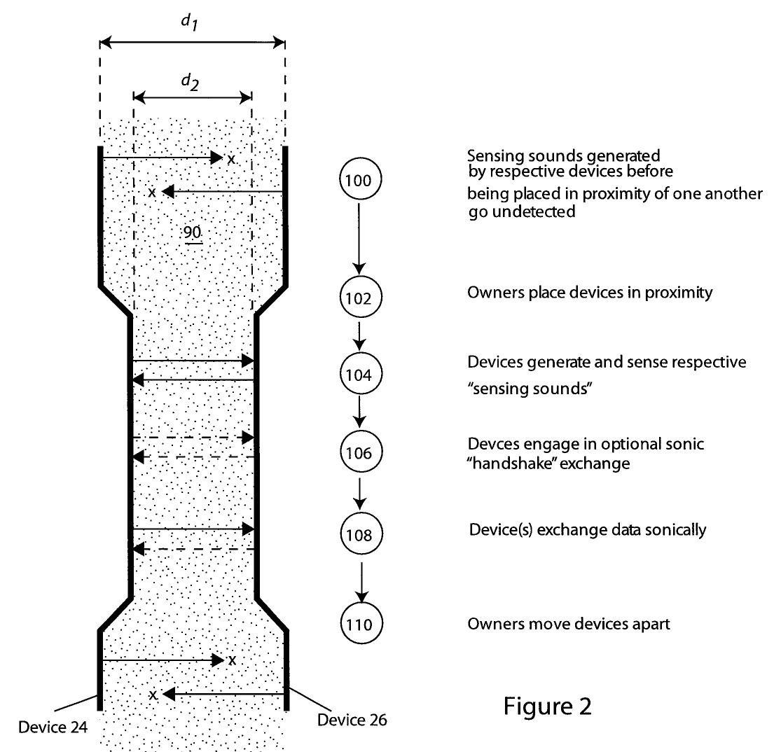

Referring to FIG. 2, in some embodiments, pairs or other groupings of devices, e.g., devices 24, 26, perform data or other information exchanges sonically, e.g., using sound waves conducted by air (or other medium) 90 between closely placed devices—or, if the devices are touching, conducted by plastic or other materials of which they are made. For those devices 20-34 which are cell phones, for example, the sonic exchange can be effected via their native microphones/mouthpieces and loudspeakers/earpieces. For other types of devices, personal digital assistants, portable computers, desktop computers, music players, watches (or time pieces), and so forth, such instrumentality can be added (e.g., at manufacture or via retrofit) to permit such exchanges.

A method of sonically encoding information transferred between the devices hereof is discussed in the Appendix hereof. Other techniques of sonically encoding information may be used instead or in addition. Selection of a particular technique depends on the expected characteristics of the devices between which exchanges will occur (e.g., cell phones), the environment in which those exchanges may occur, the amount of data expected to be transferred in typical exchanges, the expected proximity with which owners will hold their devices when making exchanges, and so forth.

The devices 24, 26 exchange data when they are sufficiently close to one another that such sonic transfers can be effected, e.g., that the sounds transmitted by the earpiece or speaker of one such device, e.g., 24, can be reliably received through the air (or other coupling medium) by the mic or earpiece of another such device, e.g., 26. This is a function of the power and sensitivity of those respective components, as well as of the ambient noise or other interference in the environment local thereto. It is also a function of the encoding method, as discussed above. In the drawing, the distance between the devices 24, 26 is denoted d₁, while the range within which they must be in order that sonic transfers can be denoted is d₂.

In some embodiments, sonic data exchanges occur “automatically” between devices whenever they are brought into range of one another. This can be by explicit or implicit agreement of the respective device owners, e.g., who place their respective devices and/or themselves (and, thereby, their respective devices) near enough one another to permit the aforementioned sonic transfers. As a practical matter, in some embodiments, this amounts to holding or otherwise placing the devices within inches or feet of one another, as would be natural and/or convenient for persons standing or sitting with one another in a locale.

Thus, for example, referring to FIG. 1 and to FIG. 2, in step 102, the owners of devices 24, 26 place their respective devices (here, represented by thick solid lines) in close enough vicinity d₂ of one another to permit sonic exchanges therebetween.

Activation of the devices 20-34 for such exchanges can be effected, for example, by adapting them to listen for and generate sensing sounds (e.g., sporadically, periodically or otherwise). See step 104. These may be unique, semi-unique and/or non-unique tones, tonal patterns, rhythmic patterns and/or other sounds. In some embodiments, these represent data such as respective device IDs, though in other embodiments, they may represent device types, classes or characteristics; owner types, classes, or characteristics; and so forth. As illustrated by contradistinction in step 100, sensing sounds generated by each of devices 24, 28 before being placed in vicinity (i.e., within the range d₂) go undetected by the other (as indicated by the x's).

Upon and/or in connection with sonically detecting the presence of one another, pairs (or other groupings) of such devices can optionally engage in a handshake, e.g., to validate one other and/or to otherwise initiate a data exchange—again, for example, based on the sonic exchange of unique, semi-unique and/or non-unique sounds that represent, for example, data such as respective device IDs, though in other embodiments, they may represent device types, classes or characteristics; owner types, classes, or characteristics; and so forth. See step 106.

Thereafter, the devices sonically exchange data representing, by way of non-limiting example, phone number(s), name(s), address(es), employment information, financial information, medical status(es), health status(es), romantic and/or marital partnership status(es), and/or other data (including, by way of non-limiting example, music files, picture files, and/or other data files). See step 108. The sonic exchanges can be in one or both directions (i.e., from one device to the other or between both devices), as indicated by the solid and dashed lines running between devices 24, 26 in that region of the drawing adjacent step 108.

In some embodiments, the devices re-execute one or more steps of the sequence 104-106 so long as the devices 24, 26 remain in the vicinity of one another, e.g, for purposes of exchanging additional data sonically. Regardless, in this embodiment, sonic data exchange ceases once the respective device owners take their devices out of range of one another. See step 110.

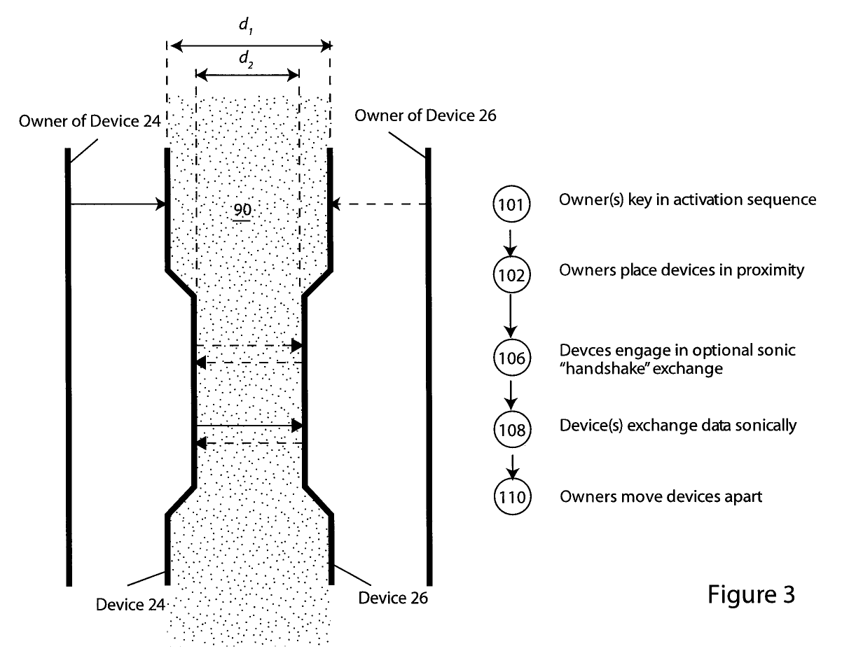

In some embodiments of the invention, sonic exchanges between the devices, e.g., 24, 26, do not occur automatically whenever they are brought into range of one another but, rather, require activation by one or more of the respective owners. This is illustrated, by way of non-limiting example, in FIG. 3. The operation of the embodiment shown there parallels that discussed above in connection with FIG. 2 (as indicated by use of like reference numerals), except as indicated below.

At the outset, it will be appreciated that although the devices 24, 26 of FIG. 3 can utilize logic and hardware to listen for and generate sensing sounds (as discussed above in connection with FIG. 2), in the example shown in FIG. 3 they do not. Instead (or in addition), one or both of the device owners strike a key (or key sequence) on their respective device(s) in order to active it (them) for a sonic data exchange. See step 101. (In alternate embodiments, such activation can be by way of owner manipulation of other actuators (e.g., a switch or switches), by voice command, selection of an icon on the respective device's screen, and so forth.) A device 26 not requiring owner activation can self-activate, e.g., by listening for sensing or other sounds generated by other device 24 in the manner of automatic activation discussed above; alternatively, or in addition, such sensing, can be part of the optional handshake exchange of step 106.

Although step 101 is shown preceding step 102, it will be appreciated that those steps can be performed at the same time or in reverse of the order shown and discussed here.

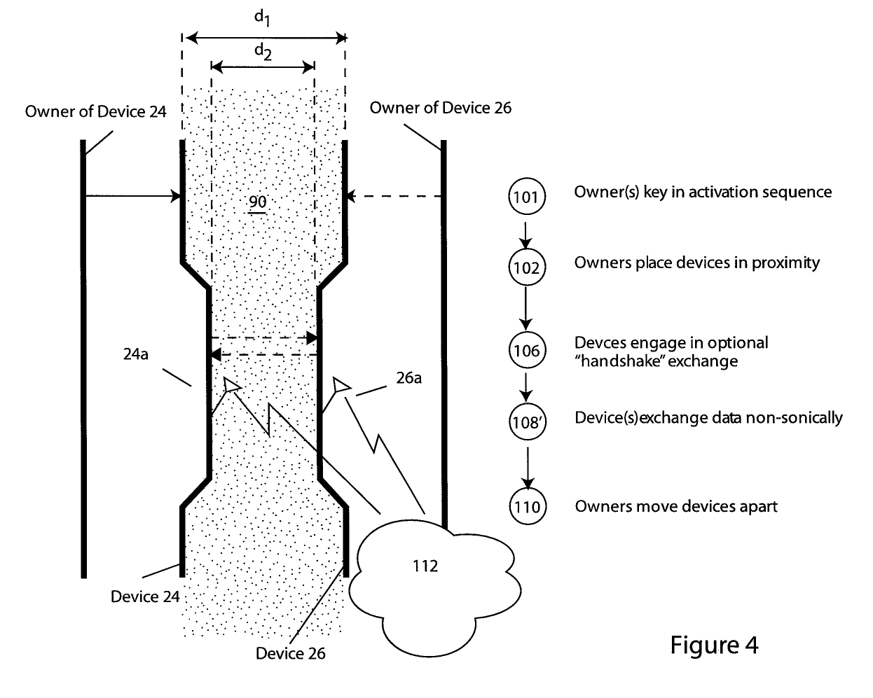

In some embodiments of the invention, not all data exchange between the devices, e.g., 24, 26, is exchanged sonically. This is illustrated, by way of non-limiting example, in FIG. 4, in which the devices 24, 26 exchange data in step 108′, e.g., via respective wireless network transceivers 24a, 26a, and network 112.

Those transceivers may comprise conventional wireless transceiver logic (hardware, firmware and/or software) and associated circuit elements (e.g., antenna) of the type commonly utilized with mobile phones (or other digital data devices with which the invention may be practiced) and of the type compatible with network 112, which may comprise networks of the type described above in connection with elements 54 and/or 66, by way of non-limiting example.

The data exchange executed in step 108′ may rely on protocol(s) conventional to network 112, or otherwise, and the data exchanged in that step may of like type to that discussed in connection with step 108, above. In addition, as above, the exchanges can be in one or both directions (i.e., from one device to the other or between both devices), as indicated by the solid and dashed lines running between devices 24, 26 in that region of the drawing adjacent step 108′. The operation of the embodiment shown in FIG. 4 otherwise parallels that discussed above in connection with FIG. 3 (as indicated by use of like reference numerals). Although step 110 is shown as following step 108″, in practice those steps may occur simultaneously or in reverse of the order shown in the drawing.

It will be appreciated that the variations shown in FIG. 4 may be applied, as well, to the embodiments shown in the other figures hereof, as well as to other embodiments of the invention, shown and/or discussed elsewhere herein, or otherwise.

Although FIG. 4 depicts a “non-sonic” exchange of data in step 108′, it will be appreciated that such an exchange (i.e., a non-sonic exchange) could occur in step 106 instead. Likewise, turning back to FIG. 2, it will be appreciated that the exchanges of steps 100, 104, 106 and/or 108 can be non-sonic, though, in embodiments that rely on sonics, at least one of those transfers is indeed a sonic transfer.

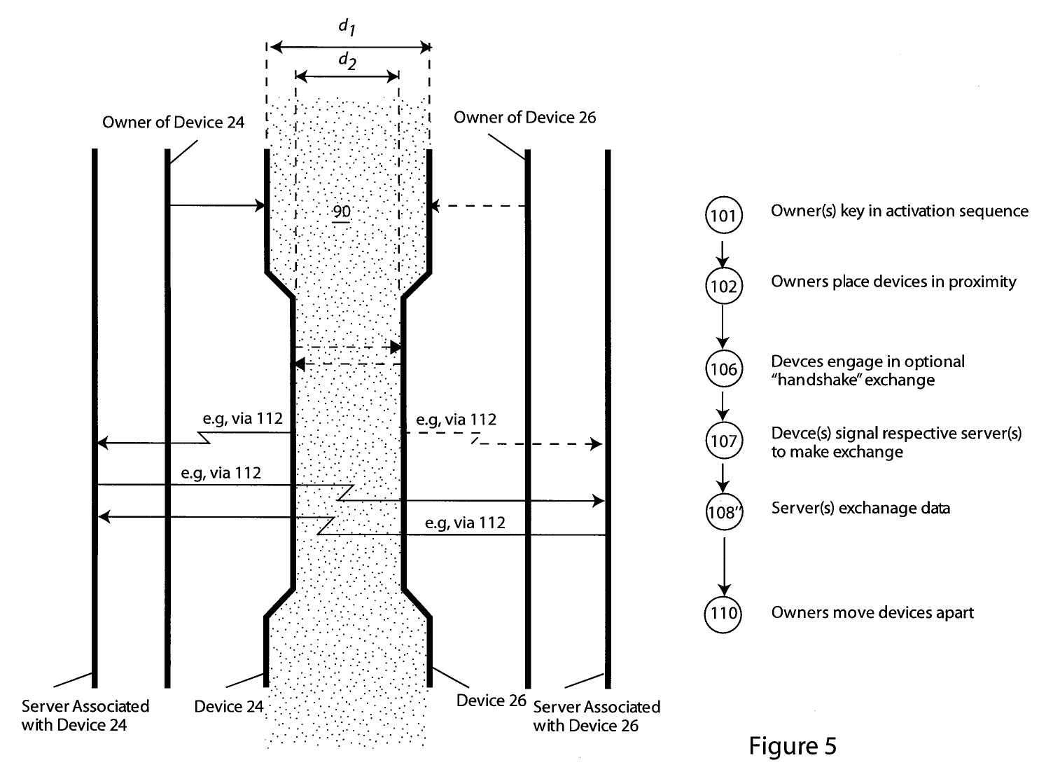

In some embodiments of the invention, an initial exchange of the data between devices, e.g., 24, 26, can effect an exchange of additional data between other instrumentalities associated with those devices and/or associated with their respective owners. This is illustrated, by way of non-limiting example, in FIG. 5, in which data exchanged during handshake step 106 effects an exchange between instrumentality 74 (FIG. 1) associated with device 24 and/or its owner and instrumentality 76 (FIG. 1). (As noted above, these instrumentalities may comprise computer systems, bank accounts, credit accounts, data services, and/or social networking site servers, all by way of non-limiting example. And, as further noted above, though shown disposed remotely, e.g, from the devices 24, 27, they may be disposed locally with respect to one or more of those devices.)

Thus, in step 107, at least one of the devices, e.g., 24 signals its respective instrumentality 74, e.g., via network 112 and/or via one or more additional digital communications networks through which they are respectively coupled, to initiate and/or participate in a data exchange with the other instrumentality 76. The other device, e.g., 26, can likewise signal its respective instrumentality 76, depending on the requirements for security, validation, etc.

Subsequently, in step 108″, the instrumentalities 74, 76 exchange data, e.g., via network 112 and/or via one or more additional digital communications networks through which they are respectively coupled. The data exchange executed in step 108″ may rely on a protocol conventional to network 112, or otherwise, and the data exchanged in that step may be of like type to that discussed in connection with step 108, above. In addition, as above, the exchanges can be in one or both directions (i.e., from one device to the other or between both devices), as indicated by the solid and dashed lines running between devices 24, 26 in that region of the drawing adjacent step 108″.

The operation of the embodiment shown in FIG. 4 otherwise parallels that discussed above in connection with FIG. 3 (as indicated by use of like reference numerals). Although step 110 is shown as following step 108″, in practice those steps may occur simultaneously or in reverse of the order shown in the drawing.

It will be appreciated that the variations shown in FIG. 5 may be applied, as well, to the embodiments shown in the other figures hereof, as well as to other embodiments of the invention.

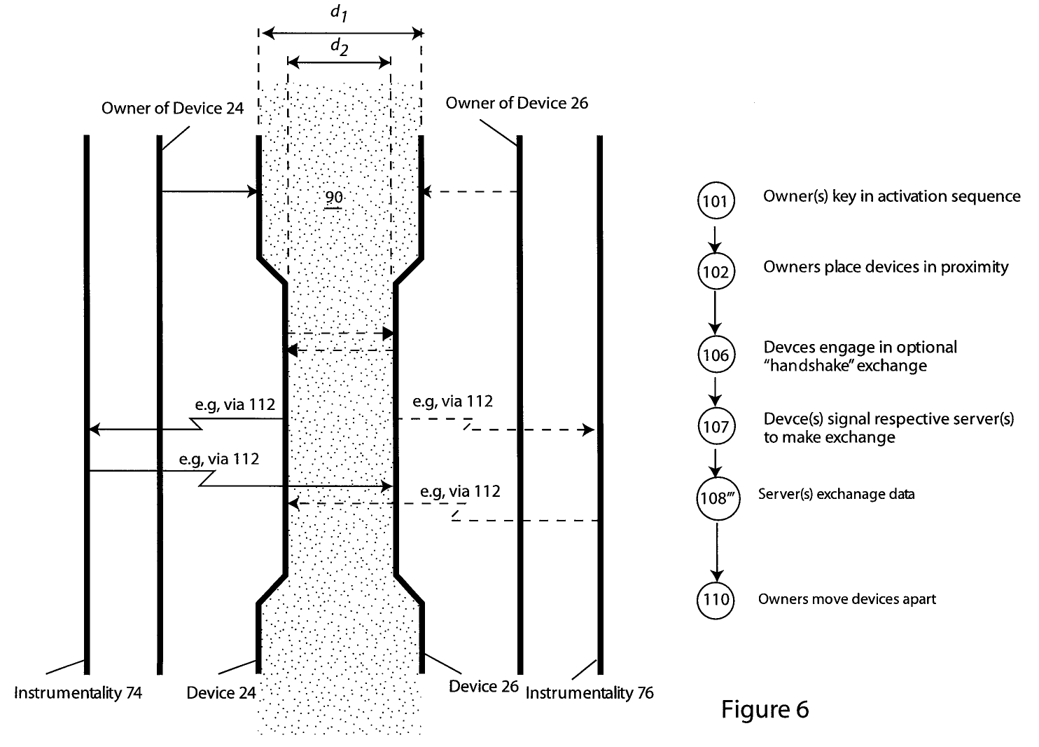

Rather than (or in addition to) exchanging data with one another, the other instrumentalities 74, 76 can exchange data with the other's respective devices 24, 26. This is illustrated, by way of non-limiting example, in FIG. 6, in which data exchanged through handshake step 106 effects an exchange between instrumentality 74 (FIG. 1) associated with device 24 and/or its owner and device 26. See step 108′″. As above, the exchanges can be in one or both directions (i.e., from each instrumentality to the others' respective device), as indicated by the solid and dashed lines running between the instrumentalities 74, 76 and devices 24, 26 in that region of the drawing adjacent step 108′″.

The operation of the embodiment shown in FIG. 6 otherwise parallels that discussed above in connection with FIG. 5 (as indicated by use of like reference numerals). It will be appreciated that the variations shown in FIG. 6 may be applied, as well, to the embodiments shown in the other figures hereof, as well as to other embodiments of the invention.

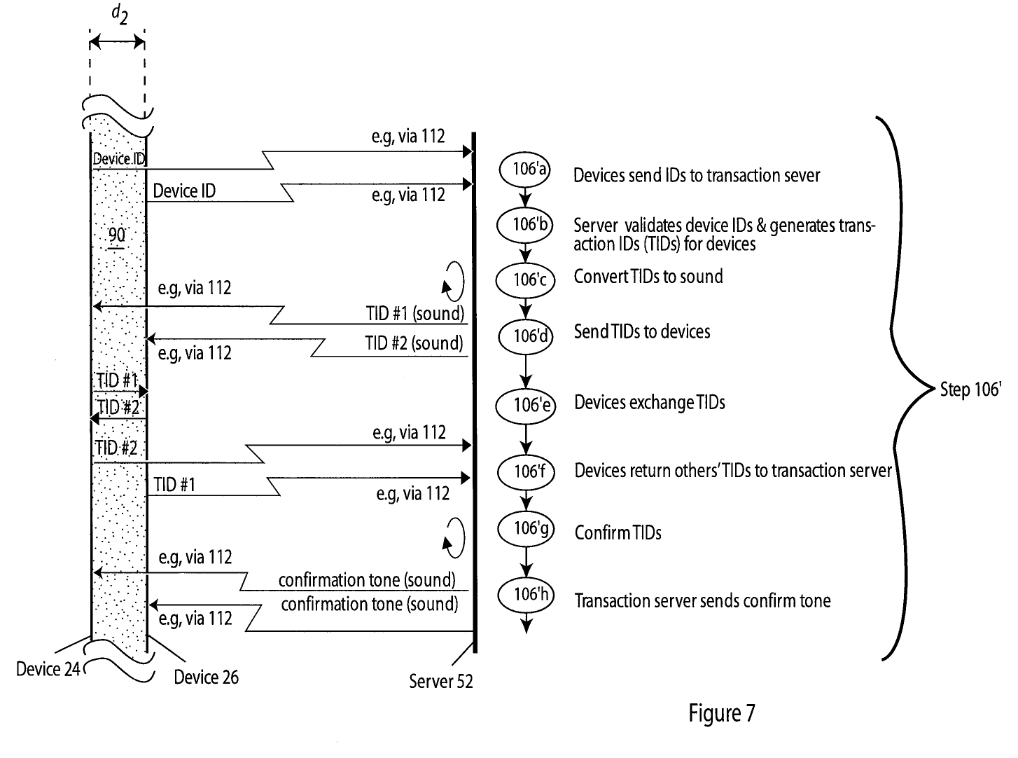

In some embodiments, the handshake executed between the devices, e.g., 24, 26, is effected via an intermediary, e.g., server 52, in order to validate the devices and/or to otherwise initiate a data exchange. This is illustrated in FIG. 7, showing details of step 106, e.g., of any of embodiments of the invention shown herein (e.g., in FIGS. 2-6) or otherwise. Of course it will be appreciated that in these and other embodiments the handshake may be effected in other ways, if at all.

Referring to FIG. 7, handshake step 106′ includes a first step 106′a, in which the devices 24, 26 transmit their respective IDs to transaction server 52. This can be via network 112 and/or via one or more additional digital communications networks through which the devices are respectively coupled to the server 52. The IDs can comprise phone numbers, EINs, MAC addresses or other unique, semi-unique or other IDs associated with the respective devices and/or their owners.

In step 106′b, server 52 validates the IDs received in step 106′a and generates transaction IDs (TID's) for each of them. Validation, which can include database lookups, remote service calls, or the like, can utilize any technique for subscriber and/or device validation, conventional or otherwise. This can include confirming not only that one or both devices are qualified—from hardware, software, subscription and/or other basis—to engage in a transaction, but also that information to be exchanged in the transfer (e.g., phone number(s), name(s), address(es), employment information, financial information, medical status(es), health status(es), romantic and/or marital partnership status(es) and/or other data (including, by way of non-limiting example, music files, picture files, and/or other data files)) is available for transfer.

The TIDs generated in step 106′b can, too, be unique, semi-unique or other IDs associated with an upcoming transaction. In the illustrated embodiment, a separate and unique TID is generated for each device 24, 26 (e.g., based on random number generation, public/private key encryption and/or otherwise); however, the same TID is generated for each device in some embodiments and, in others, that TID is selected in accord with device owner preferences and/or characteristics (e.g., ringtone-based IDs, etc.).

In step 106′c, the server 52 converts the TIDs to sounds, e.g., utilizing the methods for sonically encoding information discussed above in connection with FIG. 2. And, in step 106′d, the server 52 sends those sonically-encoded TIDs back to the respective devices 24, 26. Alternatively, or in addition, the server can send the TIDs directly to the devices and have them perform any necessary sonic encoding, e.g., prior to step 106′e, discussed below. Transmission of the TIDs (sonically encoded or otherwise) to the devices 24, 26 can be via network 112 and/or via one or more additional digital communications networks through which the devices are respectively coupled to the server 52.

In step 106′e, the devices 24, 26 sonically exchange TID's received from the server 52 (in step 106′d) using sound waves conducted by air (or other medium) 90 between the devices 24, 26. The devices 24, 26 can compare and/or otherwise validate those TIDs themselves and/or with the assistance of their respective owners (e.g., by “playing” the sonic TIDs to the owners, who can validate the tones). In the illustrated embodiment, however, each of the devices 24, 26 transmit the TIDs received from the other device (in step 106e′) back to the server 52 for validation. This can be via one or more additional digital communications networks through which the devices are respectively coupled to the server 52. See step 106′f. The server performs that validation in step 106′g, e.g., comparing the TIDs received in step 106′f against the TIDs transmitted to the devices in step 106′d and/or by decoding (or otherwise processing the) the TIDs and performing other validations on them.

Presuming the validations performed in step 106′g succeed, the transaction server 52 sends a confirm tone to the devices 24, 26. See step 106′h. In embodiments where one or more of the devices 24, 26 is subsequently responsible for initiating in information exchange (e.g., as in the case of embodiments shown in FIGS. 2-4), this tone can be a sonically-encoded unique, semi-unique or other value associated with that (or the other device) and/or with the transaction—and, preferably, is based on or otherwise associated with the IDs or TIDs exchanged in prior steps of handshake procedure 106′.

However, in embodiments, in which the server 52 itself is responsible for initiating the information exchange (e.g., as in the case of embodiments shown in FIGS. 5-6), the tone transmitted in step 106′h may need serve only as a validation to the devices and/or their respective owners that the exchange has, is or will occur. In such cases, the server 52 can perform the exchange directly, e.g., in the manner of one or more of the instrumentalities 74, 76 of FIGS. 5-6 and/or can signal those instrumentalities to perform such exchange.

Although, FIG. 7 illustrates validations to/from both devices 24, 26 and server 52, it will be appreciated that, in some embodiments, validation only occurs for one of those devices.

In some embodiments of the invention, the handshake 106 executed between the devices, e.g., 24, 26, is based on word or words spoken by the owner of either or both devices 24, 26 and/or or environmental sounds in the vicinity of those devices. Such words/sounds can be transmitted by one or both devices 24, 26 to an intermediary, e.g., server 52, which interrogates and/or compares the sounds (e.g., against each other, against known voice print(s) of the owners, and so forth) in order to validate the devices and/or otherwise initiate a data exchange. Alternatively, or in addition, the devices can compare the words/sounds themselves.

In some embodiments, the handshake 106 executed between the devices, e.g., 24, 26, is based on sounds created by tapping the devices together one (and, preferably, more) times together. Although the devices may distort acoustically, they will tend to distort less (if at all) in time. In such embodiments, one or both devices can transmit sounds picked up by their respective microphones/mouthpieces to server 52, which interrogates and/or compares the sounds (e.g., against each other, against known sound print(s) of the devices, against known tapping patterns, and so forth) in order to validate the devices and/or otherwise initiate a data exchange. Alternatively, or in addition, the devices can compare the tapping sounds themselves

In some embodiments, the handshake 106 executed between the devices, e.g., 24, 26, is based on sounds created by pressing keys one or both devices. This is particularly effective with devices, such as mobile phones, that generate tones in response to key presses. In such embodiments, one or both devices can transmit sounds picked up by their respective microphones/mouthpieces when keys are pressed on the respective devices to server 52, which interrogates and/or compares the sounds (e.g., against each other, against known key press sounds, and so forth) in order to validate the devices and/or otherwise initiate a data exchange. Alternatively, or in addition, the devices can compare the key press sounds themselves

In some embodiments, one or more data are exchanged between pairs (or other groupings) of devices optically. This is illustrated, by way of non-limiting example, in FIG. 1, in which the devices 36, 38 exchange data optically within locale 82. Such exchanges may be accomplished in the manner of any of the embodiments discussed above in connection with FIGS. 4-7, albeit utilizing infrared or other optically-based transmissions in lieu of (or in addition to) the sonic transmissions. To this end, the devices 36, 38 are equipped with infrared (or other optical) transceivers of the type commonly known in the art and encode data exchanged (e.g., in steps 106, 106′, 108′, 108″ and/or 108′″) in any manner known in the art suitable for such infrared (or other optical) transmission. As with the examples above, although only two devices 36, 38 are shown exchanging data optically within locale 82 of the drawing, in other embodiments, additional devices may be engaged in the same exchange and/or may be independently exchanging data with one another.

In some embodiments, one or more data are exchanged between pairs (or other groupings) of devices via wireless and/or wired data networks. This is illustrated, by way of non-limiting example, in FIG. 1, in which devices 44-50 (or a subset thereof) exchange data via wireless (and/or wired) network 66 that establishes a local area network within locale 84. Such exchanges may be accomplished in the manner of any of the embodiments discussed above in connection with FIGS. 4-7, albeit utilizing wireless/wired data transmissions in lieu of (or in addition to) the sonic and/or optical transmissions. To this end, the devices 44-50 are equipped with wireless transceivers (e.g., 802.11-compatible transceivers, bluetooth transceivers, and/or the like) and/or wired network transceivers (e.g., Ethernet cards) of the type commonly known in the art and encode data exchanged (e.g., in steps 106, 106′, 108′, 108″ and/or 108′″) in any manner known in the art suitable for such wireless and/or wired transmissions. As with the examples above, such exchanges may be carried about between groupings of two or more devices.

Embodiments of the type discussed immediately above lack some of the benefits inuring to embodiments utilizing sonically-based and/or optically-based data exchanges discussed earlier—i.e., the benefit that the owners must (typically) be close enough to see one another (and, therefore, to communicate and/or validate themselves and/or the prospective information transfer) before engaging their devices to exchange that information. This shortcoming can remedied, for example, through use of an identification server 68, discussed above, that is coupled to access point 64 and that facilitates identification of devices 44-50 and/or their respective owners to one another. It can additionally be remedied by using proximity detection logic instead of, or in addition to, the identification server 68.

Thus, for example, during any of steps 100-106 (including variations thereof, such as step 106′), the identification server 68 can transmit to one or more of the devices, e.g., device 44 identifier(s) representative of the other device(s), e.g., 46-50 (and/or the owner(s) thereof) in the vicinity thereof (e.g., in a communications range established by network 66 or a subnet thereof). Those identifier(s) can be, for example, picture(s), numerical code(s), name(s), and so forth. The device(s), e.g., 44, receiving such identifier(s) can display them or associated icon(s) (or other indicator(s)) to the respective owner of the device(s), e.g., 44. This is shown in the drawing, by way of non-limiting example, as icons 44a-44c (representing, by way of non-limiting example, owners of device 46-50, respectively).

The owner of the receiving device(s), e.g., 44, can use his keyboard or other input device (e.g., touch screen) to select which of the other device(s) which to exchange data. This is shown, by way of non-limiting example, in the drawing by checkboxes 44d-44f corresponding to selection of devices 46-50 represented by icons 44a-44c, respectively.

More specifically, in the illustrated embodiment, selection of those icons 44a-44c (and/or the corresponding checkboxes 44d-44f, by way of non-limiting example) activates the selected device(s)—here, devices 46, 48 (corresponding to icons 44a, 44b and/or checkboxes 44d, 44e —for the exchange (in the case of use of server 68 during step 100) of data with selecting device, e.g., 44, completion of the handshake (in the case of use of the server 68 during handshake steps 106, 106′) with that device, and so forth.

By way of further example, during any of steps 100-106 (again, including variations therefor, such as step 106′), proximity logic can be used to determined the relative proximity of devices 44-50 and, thereby, to activate the device(s) for data exchange (e.g., in the manner analogous to that discussed above in connection with steps 100-104). Instead or in addition, such proximity logic can be used to filter identifiers (or other associated indicia) displayed on one (or more) of the devices, e.g., 44, for selection of the other device(s) and/or their associated owner(s) to activate the devices for exchange, to complete the handshake therebetween, or otherwise, pursuant to the discussion immediately above.

The proximity logic can comprise any mechanism known in the art suitable for such purpose on devices 20-50. This can include, for example, GPS or other location-determining mechanisms, Bluetooth or other range-limited networking devices, and so forth. Such logic can be implemented on any of devices, e.g., 44, 46, access point 64 and/or identification server 68, by way of non-limiting example, method is not to send an audio signal at all, rather to use a sound naturally produced between the two phones. Speaking a word or phrase into both phones produces a distinct sound in both mouth pieces, which then can be matched by the Server. A variation of this is tapping both phones together a number of times. Although cell phones distort acoustically they do not distort in time; the precise duration between clicks can be matched on the server. Similarly, holding a key down on one of the phones will create a tone whose precise duration can be matched on the server.

The embodiments shown in the drawings and described above meet the objects set forth earlier. Thus, by way of non-limiting example, they facilitate information exchange utilizing personal electronic devices even between (and among) individuals meeting in person. It will be appreciated, however, that those embodiments are merely examples of the invention and that other embodiments, incorporating changes from those shown and described herein, fall within the scope of the invention.

Thus, by way of non-limiting example, whereas the embodiments described above utilize sonic, optical, wireless and/or wired communications media for data exchange, other embodiments may utilize electrical, electomechanical, magnetic or mechanical mechanisms in lieu and/or in addition thereto. These exchanges can be effected, for example, by mating lock-and-key, tongue-and-groove or other mechanical mechanisms whose interactions (e.g., contact pressure) are, preferably, variable to permit encoding of exchanged data; by a magnetic switch and/or key mechanism that is, again, preferably variable; and, so forth.

### APPENDIX

In embodiment of the invention intended for use with mobile phones operating in accord with FIGS. 6 and 7, codes representing device IDs, transaction IDs and other information transmitted from one device, e.g., 24, to another are kept small to accommodate low fidelity of microphones/mouthpieces and loudspeakers/earpieces native to most mobile phones, as well as to accommodate background noise present in many locales 80-84. The length of the code in such embodiments is approximately three bytes, which is sufficient to distinguish among over one million devices concurrently accessing the server 52. Approximately one additional byte is added as a checksum.

In order to minimize the effect of background noise on sonic transmissions between the devices, the transmitting device, e.g., 24, uses a sine wave at a fixed frequency to carry the code. In some embodiments, 3000 Hz has proven effective frequency, though, other embodiments may utilize other frequencies. A single bit is transmitted for a duration of 10 to 100 cycles, yielding different degrees of robustness with respect to distance between the phones and amount of background noise. A heading is used of 3 alternating l's and O's to mark the beginning of the signal. Again, a checksum is added to the end.

To decode the signal, the receiving device, e.g., 26, employs a band-pass in software. A Fast Fourier Transform (such as the Python *libfft* module, by way of non-limiting example) is used to measure signal intensity in at band at and around the fixed frequency of the transmitting device, e.g., 3000+/−100 Hz (though, other embodiments may utilize larger or smaller bands). This intensity, I[s], is compared with the total signal intensity at frequencies outside the band, I[b]. When the ratio I[s]/I[b] exceeds a threshold T, a ‘1’ is decoded, otherwise a ‘0’ is decoded.

This threshold, T can vary with any given transmitted signal. Accordingly, software (or other functionality) executing on the receiving device, e.g., 26, iterates on different candidate values for T to find one decodes the signal successfully, according to the checksums.

In some embodiments, the receiving device employs a smoothing heuristic where, if a pulse of duration 10 ms˜100 ms contained in a received sonic transmission is interrupted for a duration of 0.1˜1.0 milliseconds, that interruption is removed so the pulse remains intact.

The transmitting device, e.g., 24, repeats the sonic transmission, e.g., from two to ten times (or more) and, preferably, three to five times, to maximize the chances of a successful decoding. However, in a preferred embodiment, the signal is not sent out in regular pulses—since this would create the possibility that both the transmitting device and receiving device would be emitting the sound at the same time, such that self-noise (e.g., each devices' own transmission) would interfere with the ability to ‘hear’ the other device's transmission. Rather, the pulse is sent randomly with a 50% probability of transmittal each time.

1. A system for exchange of data, comprising:
A. first and second portable digital devices,
B. the first and second portable digital devices exchanging first data when placed in a range of one another,
C. the first and second portable digital devices exchanging said first data sonically.

2. The system of claim 1, wherein the range is one within which the first and second devices can sonically couple.

3. The system of claim 1, wherein the portable digital devices comprise cell phones.

4. The system of claim 1, wherein the portable digital devices comprise any of cellular phones, personal digital assistants, music players, time pieces, or other portable electronic devices.

5. The system of claim 1, wherein the first and second portable digital devices are associated with first and second entities, respectively, and wherein said first data comprises information regarding any of the first and/or second entities.

6. The system of claim 5, wherein such information comprises any of phone number, name, address, employment information, financial information, medical status, health status, romantic and/or marital partnership status.

7. The system of claim 1, wherein the first and second portable digital devices exchange said first data when at least one of them is activated by the respective entity associated therewith for exchange of said first data.

8. The system of claim 1, wherein the first and second portable digital devices exchange said first data when both of them are activated by the respective entity associated therewith for exchange of said first data.

9. The system of claim 7, wherein at least one of said first and second portable digital devices is activated for exchange of said first data by any of manipulation of a button or other actuator.

10. The system of claim 7, wherein at least one of said first and second portable digital devices is activated for exchange of said first data by voice command.

11. The system of claim 1, wherein the first and second portable digital devices exchange first data in both directions therebetween.

12. The system of claim 1, wherein the first and second portable digital devices exchange second data subsequent to exchange of said first data.

13. The system of claim 12, wherein the exchange of said first data effects an exchange of said second data between the first and second portable digital devices.

14. The system of claim 13, wherein the first and second portable digital devices exchange said second data sonically.

15. The system of claim 14, wherein the first and second portable digital devices exchange said second data in both directions therebetween.

16. The system of claim 12, wherein the exchange of said first data effects an exchange of said second data between one or more other instrumentalities associated with the first and second portable digital devices and/or entities associated therewith.

17. The system of claim 16, wherein at least one of the first and second devices initiates transfer of said second data via said one or more other instrumentalities.

18. The system of claim 17, wherein at least one of the first and second devices communicates via a data network in order to initiate transfer for said second data via said other one or more other instrumentalities.

19. The system of claim 16, wherein the other instrumentalities include any of computer systems, banking accounts, credit accounts, data services, and social network sites.

20. The system of claim 1, wherein the first and second portable digital devices exchange said first data irrespective of any of (i) prior association of the first and second portable digital devices with one another, and (ii) prior association of entities associated with the first and second portable digital data devices.

21-84. (canceled)
